(19) United States
(12) Patent Application Publication
(10) Pub. No.: US 2010/0197295 A1
(43) Pub. Date: Aug. 5, 2010

(54) Femtocell Base Station

(76) Inventor: Basil Horangic, Menlo Park, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/695,115

(22) Filed: Jan. 27, 2010

Related U.S. Application Data
(60) Provisional application No. 61/148,796, filed on Jan. 30, 2009.

(51) Int. Cl. H04B 7/00; H04W 4/00

(52) U.S. Cl. 455/422.1; 370/338; 455/41.2

(57) ABSTRACT

In one aspect, there is provided method. The method may include determining, at a base station, identity information for a mobile station, the base station configured to determine the identity information when the mobile station is in a proximate contact with the base station; and providing the identity information to a message generator. Related systems, articles, and methods are also described.

### CROSS-REFERENCE TO RELATED APPLICATION

This application claims the benefit of U.S. Provisional Patent Application Ser. No. 61/148,796, filed on Jan. 30, 2009 and entitled “FEMTOCELL BASE STATION,” which is incorporated by reference herein in its entirety (Attorney Docket No. 38713-501P01US).

### FIELD

The subject matter described herein relates to wireless communications.

### BACKGROUND

A femtocell is a cellular base station configured for a very small coverage area, such as a residence, a small business, and the like. The femtocell base station typically has less range and power, when compared to a typical base station. A femtocell base station allows a service provider to extend service coverage indoors where the coverage may be limited or offload traffic off their primary base stations. The femtocell base station has similar functionality to a typical base station in many respects but the femtocell base station but may include additional functionality to allow for a self-contained deployment at, for example, a residence or small business.

### SUMMARY

The subject matter disclosed herein provides a femtocell base station configured to determine identifying information about a mobile station and/or its user, when the mobile station is proximate to the femtocell base station.

In one aspect, there is provided a method. The method may include determining, at a base station, identity information for a mobile station, the base station configured to determine the identity information when the mobile station is in a proximate contact with the base station; and providing the identity information to a message generator.

The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a network including the femtocell base station;

FIG. 2 depicts a process for using the femtocell base station; and

FIG. 3 depicts another block diagram of a network including the femtocell base station with a plurality of antennas.

Like labels are used to refer to same or similar items in the drawings.

### DETAILED DESCRIPTION

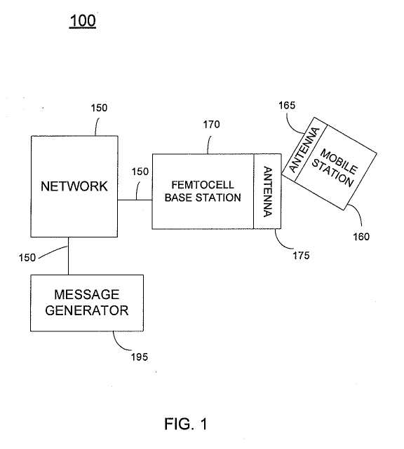

FIG. 1 depicts a system 100 including a mobile station 160, a femtocell base station 170, a network 150, and a message generator 195.

The mobile station 160 further includes an antenna 165. The mobile station 160 is often referred to as, for example, a mobile station, a mobile unit, a subscriber station, a wireless terminal, or the like. A mobile station can be, for example, a wireless handheld device, a vehicle mounted device, a portable device, a wireless plug-in accessory, or the like. In some cases, a client station can take the form of a handheld computer, notebook computer, wireless telephone, personal digital assistant, wireless email device, personal media player, or the like and may include a display mechanism, microphone, speaker, and memory. However, in most implementations, the mobile station 160 and antenna 165 are implemented as a wireless handheld device, which communicates with femtocell base station 170 and antenna 175.

Base station 170 is a base station configured to operate with a very limited coverage area, such as 24 inches, and, in some implementations, less than about 6 inches. For example, base station 170 is capable of wirelessly communicating with a mobile station 160 only when mobile station 160 is either within 6 inches of the base station 170 or within 6 inches of antenna 175.

In some implementations, the base station 170 is implemented as a femtocell base station 170 configured to have a coverage area of about 6 inches. The femtocell base station coverage area can be limited by a variety of mechanisms. For example, the power of the base station 170 may be limited to provide the 6 inches of coverage area. In addition, the antenna 175 may be configured to provide that limited coverage area (e.g., antenna switching, smart antenna techniques, beamforming, using electromagnetic absorptive materials to reduce emanations from antenna 175, and the like). In some implementations, a commercially available femtocell base station, which typically emits about 15 dBm of power and has a coverage area of about 50 meters, is configured to have range of 6 inches.

In some implementations, femtocell base station 170 is configured to determine identifying information (e.g., Internet Protocol (IP) address, phone number, and the like) of the mobile station 160 (and/or user of the mobile station 160) when the mobile station 160 is in, for example, proximate contact to femtocell base station 170.

In some implementations, the femtocell base station 170 may determine identifying information for a mobile station 160 in conjunction with, for example, a conscious and distinct physical set of actions by a user of the mobile station. These conscious and distinct physical set of actions may indicate an intention to opt into a proposal identified with those actions if executed at the antenna of the base station. The proposal may comprise information including items, such as a receipt of goods and services, a registration, a coupon, an approval/disapproval, and the like.

For example, the actions may indicate that the user of the mobile station 160 accepts a proposal to receive information, provide information, receive something of value (e.g., a coupon, a credit, and the like), and/or provide something of value. A user may contact the antenna 175 using mobile station 160 or move the mobile station 160 in a predetermined pattern close to the antenna 375A (e.g., moving the mobile station 160 in a figure eight pattern, check mark pattern, a single tap, a double tap, etc.) to signify an opt-in. The opt-in may enable the mobile station 160 and the base station 170 (or other systems coupled to the base station) to exchange (e.g., provide identifying information regarding the user and/or receive information from message generator 195).

The identifying information may include any information identifying the mobile station (or its user). Examples of identifying information include one or more of the following: an Internet Protocol (IP) address of the mobile station; a Media Access Control address of the mobile station; a phone number of the mobile station; an International Mobile Subscriber Identity (IMSI); and an International Mobile Equipment Identity (IMEI), an Electronic Serial Number (ESN), a Mobile Equipment Identifier (MEID), a Mobile Directory Number (MDN), a Mobile IP address, a web address, a physical identifier of the mobile station 160, a network subscriber identifier, a network directory identifier, and/or other information that can serve to directly identify the possessor of the mobile station or indirectly identify the possessor by using that information to reference other directories.

In some cases, the identifying information may be obtained in a cooperative manner. For example, the user may provide the identifying information by opting into the network 100. Alternatively, the user of mobile station 160 may provide identifying information directly to the base station 170. For example, when the mobile station 160 is in proximate contact with the antenna 170, the mobile station (or the user of the mobile station) may directly provide information identifying the user (and the mobile station 160) to the base station 170.

For example, the identifying information may be obtained by the base station as part of the one or more handshake messages typically exchanged between the base station and mobile station. Alternatively, the identifying information may be provided by using the message generator 195. Specifically, the message generator 195 may provide a page, a link to a page, or a message, which when displayed allows the user of mobile station 160 to provide identifying information to base station 170. For example, the user of mobile station 160 may directly enter into the page (or into a message) the ESN of the mobile station 160 as well as the user's name and the phone number of the mobile station. The page (or the message) may then be provided to the base station 170.

In some implementations, a subscriber of the mobile station may access a website and provide information identifying at least one of the mobile station (e.g., an IP address, a MAC address, and the like) and the user (e.g., a name, an ESN, and the like). The provided information may be stored at directory 390 and used to indicate that the subscriber has opted into the system. This opt in enables the system to recognize the subscriber, when the subscriber's mobile station is in proximate contact with antennas 375A-D. As such, the subscriber's mobile station receives information from the message generator 195.

The message generator 195 may provide information to the mobile station 160 as a result of the opt-in (or, e.g., proximate contact) between the mobile station 160 and antenna 165. The information may include coupons, product information, money, video clips, audio clips, ring tones, music, and the like. The information exchanges between the message generator 195 and the mobile station 160 (or its user) may be performed via in a variety of ways including via the wireless network, short message service (SMS) messages, voice messages, video messages, documents, directions to a web site, a two way interactions (e.g., a voice or video call), an exchange of a sequence of SMS messages, an interaction with a downloaded software agent, or remote interaction with a software agent. Exchanges may be informational or may include other opt-in approvals, such as confirmation of potential payments identified in the interaction.

In some implementations, femtocell base station 170 is part of a network to which mobile station 160 can cooperatively enter and access. For example, base station 170 may be part of the allowable network(s) to which mobile station can connect. Typically, mobile station 160 has a list of networks (e.g., a list of public land mobile network (PLMN)) to which it is allowed to connect to. Moreover, in some implementations, base station 170 is integrated into a carrier's network, so that the mobile station's access to base station 170 represents access and entry into the carrier's network. In this cooperative mode, mobile station 160 exchanges messages with base station 170 to gain access to base station 170. Once base station 170 determines the identity of the mobile station 160 (or the user), the identifying information is provided to message generator 195 via network 150. Next, message generator 185 generates a message for mobile station 160. The generated message is sent to network 150, base station 170, and mobile station 160. In some implementations, once femtocell base station 170 determines the identity of mobile station 160, base station 170 releases its connection with mobile station 160.

In a non-cooperative mode, base station 170 may determine identifying information without the mobile station 160 gaining full network accesses to the network associated with base station 170. Once base station 170 determines the identity of the mobile station 160 (or the user), the identity information is provided to message generator 195 via network 150. Next, message generator 195 generates a message to mobile station 160. The generated message is sent to network 150, base station 170, and mobile station 160. In some implementations, once femtocell base station 170 determines the identity of mobile station 160, base station 170 releases its connection with mobile station 160.

As noted, information identifying the mobile station 160 may be acquired through the existing handshake mechanisms incorporated in the mobile handset, with or without full completion of the handshake and with or without cooperation of the network service provider to whom the holder of the mobile device has subscribed. After this initial contact between the mobile station and the base station, subsequent exchanges may be via the same connection used by the base station for identification, or though a different connection network that connects the message generator 160 with the mobile station 160.

In some implementations, the message received at mobile station 160 from the message generator 195 may be a short message service (SMS) message. Moreover, the message may be generated based on the opt-in (e.g., proximate contact or other action) between the mobile station 160 and the base station 170. For example, base station 170 and/or antenna 175 may be placed adjacent to a good being sold and labeled as an opt in location. A user of mobile station 160 may place mobile station 160 and/or antenna 165 in proximate contact to the antenna 175 and/or base station 170. This proximate contact represents a so-called “opt-in” to receive information, such as a message generated by message generator 195, regarding the good being sold. For example, a user may bring mobile device 160 (and/or antenna 165) into proximate contact with antenna 175 (and/or base station 170) to receive a SMS message (which is addressed using the determined identity information of the user or mobile station) with a discount coupon for the good, which is adjacent to antenna 175 and/or femtocell base station 170.

Although the above example describes message generator 195 generating a message in response to the proximate contact between the base station and mobile station, the message generator 195 may generate and send other information. Examples of such information include one or more of the following: advertising, payment authorizations, video, audio, coupons, and the like. Moreover, in some implementations, message generator 195 may be a gateway providing information from other sources as well. Furthermore, the message generator 195 may use other communication mechanisms to provide the information to the user as a result of the opt-in. For example, the message generator 195 may cause a direct mailing to be sent to the user via the U.S. Postal Service, a voice mail to be sent via a phone line, or a page to be generated at a web site.

In this description, the communication path from the base station 170 to the mobile station 160 is referred to as a downlink and the communication path from the mobile station 160 to the base station 170 is referred to as an uplink. The uplink and downlink may be implemented in accordance to a wireless standard, such as GSM, CDMA, UMTS, and the like.

In a typical system, the base station 170 can also communicate over a backhaul network 150 with other femtocell base stations and a network control module for network administration and coordination as well as other overhead, coupling, and supervisory functions. Network 150 may be any type of communications mechanism and may include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide network 150. Moreover, network 150 may be embodied using bi-directional, unidirectional, or dedicated networks. Communications through network 150 may also operate with standard transmission protocols, such as Transmission Control Protocol/Internet Protocol (TCP/IP), Hyper Text Transfer Protocol (HTTP), SOAP, RPC, or other protocols.

Message generator 195 may be used to generate messages in response to a proximate contact between a mobile station and a base station. The proximate contact may generate a message unique to that contact. For example, if the base station antenna were located adjacent to a cereal aisle (or, e.g., a specific brand of cereal) at a supermarket, the proximate contact would send an SMS message including a coupon for cereal. Similarly, when the base station antenna is located adjacent to the candy aisle (or, e.g., a specific brand of candy) at the supermarket, the proximate contact would result in an SMS message being sent, but in this case the message would include a coupon for candy. Although the examples herein describe the message generator 195 generating messages in response to the opt-in (e.g., a proximate contact), any information may be generated by the message generator 195 in response to the proximate contact. For example, a live call may be made to the user's mobile device, a video and/or audio file may be sent (e.g., an advertisement), a hypertext mark-up language (HTML) web-based advertisement, and the like.

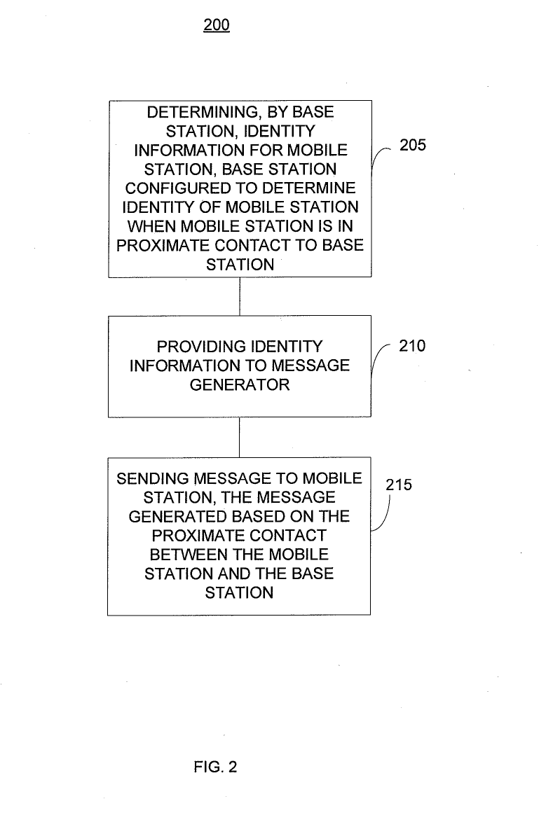

FIG. 2 depicts a process 200 used in connection with, for example, femtocell base station 170. The description of FIG. 2 also refers to FIG. 1.

At 205, the identity information of the mobile station is determined. For example, base station 170 may determine the identity of mobile station 160 when mobile station 160 is in proximate contact to mobile station 170. Moreover, base station 170 may determine the identity of mobile station 160 (or its user) in a cooperative manner or a non-cooperative manner, both of which are described above.

At 210, the determined identity information is provided to a message generator. For example, base station 170 may provide the determined identity information to message generator 195 through network 150. For example, the mobile station's phone number may be determined.

At 215, the message generator 195 may send a message to mobile station 160. Moreover, the message generator 195 may generate the message based on the opt-in (e.g., proximate contact) between the mobile station 160 (or its antenna) and the base station 170 (or its antenna). For example, the proximate contact may generate a message unique to that contact. In this example, if the base station antenna 175 is placed adjacent to a product or a service being sold (or displayed by a retailer), the proximate contact between the mobile station 160 and the base station 170 would result in information, such as an SMS message, being sent to mobile station 160. For example, the SMS message may include a coupon for the corresponding good or service associated with the proximate contact.

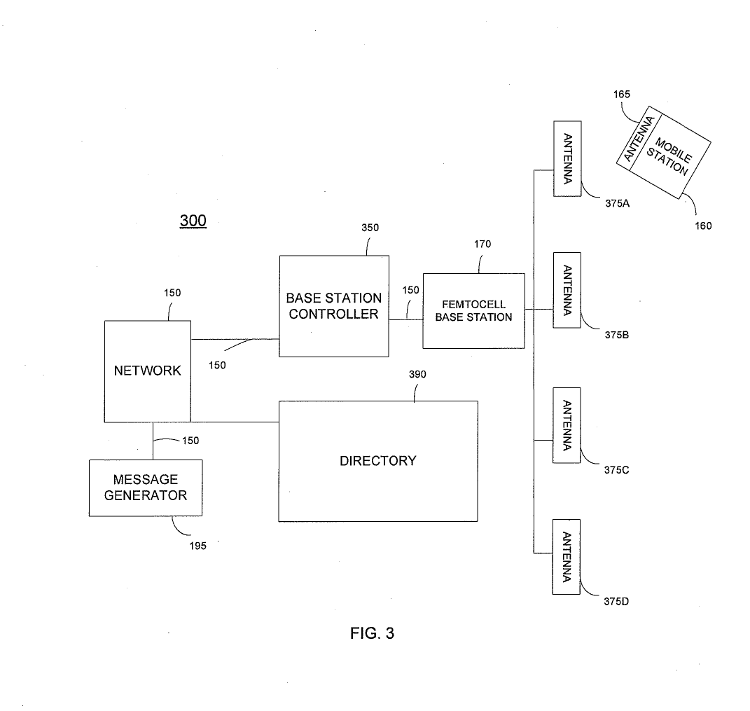

FIG. 3 depicts a system 300. System 300 is similar to system 100. However, system 300 includes a plurality of antennas 325A-D coupled to femtocell base station 170. Moreover, femtocell base station 170 is further coupled to a base station controller 350. The single base station 350 may be used to identify one or more proximate contacts between mobile stations and the antennas 375A-D.

The system 300 further includes a directory 390. This directory 390 includes identifying information of one or more mobile stations, which have opted into system 300 to exchange information with message generator 195. For example, directory 170 may include identifying information for the mobile stations and/or a subscribing user, such as an ESN to identify a user and associated mobile station 160. The ESN may be used to identify the subscriber and the mobile station, without completing the typical full handshake required by a base station and mobile station (e.g., without transferring the mobile station's current network service provider base station to the femtocell base station 350).

Although the directory 390 is only depicted at FIG. 3, in some implementations, system 100 also includes a directory, such as directory 390.

In the implementation of system 300, each of the antennas 325A-D is placed adjacent to one or more goods (or services). When a user of the mobile station 160 places the mobile station 160 very close to one of the antennas 375A-D, process 200 is performed using the antenna, which was in proximate contact with mobile station 160 and/or antenna 165. Moreover, femtocell base station 170 may include antenna technology (e.g., antenna switching, beamforming, multiple-input, multiple output (MIMO), or the like) to determine from which antenna the proximate contact was made.

In an implementation, each of the antennas 375A-D is placed adjacent to a corresponding good (or service). If the user of mobile station 160 is interested in obtaining additional information regarding a product (e.g., coupons, product information, technical support, and the like), the user makes proximate contact with the antenna which is adjacent to that product.

In some implementations, a commercially available femtocell base station (e.g., Motorola's 800 Series Femtocell Access Point) is configured to operate as described herein. This configured femtocell base station provides a near field communication link with a mobile station (e.g., a cell phone) without requiring any modifications in hardware or software to the mobile station. Moreover, in some cases, the femtocell base station may identify the mobile station in a cooperative manner, although in some cases such cooperation may not be necessary. Further, in the non-cooperative case, the femtocell base station is simply used to capture the phone number of the mobile station. The mobile station is not fully handed off to the femtocell base station (e.g., just enough of a handoff transaction is conducted to capture the phone number, and then the mobile station is disconnected from the femtocell base station). The mobile station may then reconnect with its assigned network and base station.

In some implementation, the femtocell base station is configured so that the mobile station must be within 1 centimeter to achieve proximate contact. This configuration may be achieved by reducing the power of the femtocell base station and/or modifying the antenna. Moreover, this proximate contact between the mobile station and base station can be considered a single opt-in (i.e., consent) for a so-called “double opt-in” cellular marketing transaction, and therefore implicit permission to start a communication with the mobile station. In some implementations, the user of the mobile station may double tap the base station to achieve a double contact, in which case the double tap constitutes a double opt-in—instantly enabling the transaction between the message generator and mobile station.

In some implementations, the subject matter described herein includes one or more of the following advantages. Unlike near field technologies that require additional hardware and/or software on the mobile station (or try to use existing infrared (IR), Bluetooth, imaging, or WiFi chips), the above-described femtocell base station process opens the door to a dream scenario of requiring no additional hardware or software on the mobile station, providing instant compatibility with every mobile station, such as a cell phone. Moreover, in some implementations, the primary function of the femtocell is to determine the mobile stations identifying information given a proximate contact and then providing that information to the message generator. As such, the femtocell base station may be implemented with less functionality than a typical femtocell base station. Moreover, given the very low power required to achieve a proximate contact (e.g., sufficient power must be transmitted by the femtocell base station for transmission within a coverage area less than 24 inches), the power of the radio transmission is extremely low and, likely under FCC Part 15 levels. Therefore, the transmission may not necessarily even need the carrier's permission to use their spectrum.

In some implementations, the process 200 is used to obtain product Information. For example, a user taps a cell phone under a product on a retailer's shelf (configured with a femtocell base station or its antenna) and instantly receives a call from the manufacturer's customer support answering questions regarding the product. In some implementations, the process 200 is used to obtain documentation, i.e., tap your phone on another spot on the shelf and instantly have all of the product documentation downloaded to your phone. In some implementations, the process 200 is used in connection with advertising. For example, a user taps a cell phone on a billboard in an airport and then a video (related to the billboard) is played on the user's mobile station. In some implementations, the process 200 is used in connection with payments. For example, a user taps a cell phone on a cash register (or point of sale device) and the mobile station receives a message asking with the user approves payment for a purchase (e.g., $121.34).

The subject matter described herein may be embodied in systems, apparatus, methods, and/or articles depending on the desired configuration. In particular, various implementations of the subject matter described, such as the components of base stations, client stations, macrodiversity controller, and processes described herein, may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. For example, the components of base station, message generator, and aspects of processes described herein may be realized in digital electronic circuitry, integrated circuitry, specially designed ASICs (application specific integrated circuits), computer hardware, firmware, software (including computer programs), and/or combinations thereof.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
determining, at a base station, identity information for a mobile station, the base station configured to determine the identity information when the mobile station is in a proximate contact with the base station; and
providing the identity information to a message generator.

2. The method of claim 1, wherein the identity information includes
one or more of the following: an Internet Protocol (IP) address of the mobile station; a media access control address of the mobile station; a phone number of the mobile station; an international mobile subscriber identity (IMSI); and an international mobile equipment identity (IMEI).

3. The method of claim 1, wherein the base station is a femtocell base station.

4. The method of claim 1, wherein the proximate contact comprises a physical contact between the base station and the mobile station.

5. The method of claim 1, wherein the proximate contact comprises substantially close contact between the base station and the mobile station.

6. The method of claim 1 further comprising:
sending, by a message generator, a message generated based on the proximate contact between the mobile station and the base station.

7. The method of claim 6 further comprising:
generating the message as a short message service message.

8. The method of claim 6 further comprising:
including, in the message, information targeted to at least one of a product and a service in an area associated with an antenna of the base station.

9. The method of claim 1 further comprising:
receiving an indication of the proximate contact from one of a plurality of antennas coupled to the base station.

10. The method of claim 1 further comprising:
configuring, at the base station, at least one of a power and an antenna to limit proximate contact to less than about 6 inches.

11. A system comprising:
a processor; and
a memory, wherein the processor and the memory are configured to perform a method comprising:
determining, at a base station, identity information for a mobile station, the base station configured to determine the identity information when the mobile station is in a proximate contact with the base station; and
providing the identity information to a message generator.

12. The system of claim 11, wherein the identity information includes
one or more of the following: an Internet Protocol (IP) address of the mobile station; a media access control address of the mobile station; a phone number of the mobile station; an international mobile subscriber identity (IMSI); and an international mobile equipment identity (IMEI).

13. The system of claim 11, wherein the base station is a femtocell base station.

14. The system of claim 11, wherein the proximate contact comprises a physical contact between the base station and the mobile station.

15. The system of claim 11, wherein the proximate contact comprises substantially close contact between the base station and the mobile station.

16. A computer-readable medium containing instructions to configure a processor to perform a method, the method comprising:
determining, at a base station, identity information for a mobile station, the base station configured to determine the identity information when the mobile station is in a proximate contact with the base station; and
providing the identity information to a message generator.

17. The computer-readable medium of claim 16, wherein the identity information includes
one or more of the following: an Internet Protocol (IP) address of the mobile station; a media access control address of the mobile station; a phone number of the mobile station; an international mobile subscriber identity (IMSI); and an international mobile equipment identity (IMEI).

18. The computer-readable medium of claim 16, wherein the base station is a femtocell base station.

19. The computer-readable medium of claim 16, wherein the proximate contact comprises a physical contact between the base station and the mobile station.

20. The computer-readable medium of claim 16, wherein the proximate contact comprises substantially close contact between the base station and the mobile station.
